(19) United States
(12) Patent Application Publication
(10) Pub. No.: US 2025/0219753 A1
(43) Pub. Date: Jul. 3, 2025

(54) LATENCY MEASUREMENT IN A COMMUNICATION DEVICE

(71) Applicant: Marvell Asia Pte Ltd, Singapore (SG)

(72) Inventors: Tu CAO, Vancouver (CA); Whay Sing LEE, Milpitas, CA (US); Srinivas SWAMINATHAN, San Jose, CA (US); Shaun LYTOLLIS, Bristol (GB); Arash FARHOODFAR, Milpitas, CA (US)

(21) Appl. No.: 18/999,875

(22) Filed: Dec. 23, 2024

Related U.S. Application Data
(60) Provisional application No. 63/615,537, filed on Dec. 28, 2023.

(51) Int. Cl. H04J 3/06; H04L 1/00

(52) U.S. Cl. CPC H04J 3/0667; H04L 1/0041

(57) ABSTRACT

A first communication interface of a communication device receives a data signal having first alignment markers (AMs), and the communication device determines respective locations of the first AMs in the data signal. The communication device processes the data signal, including i) removing the first AMs from the data signal and ii) inserting second AMs in the data signal at the locations at which the first AMs were removed from the data signal. A second communication interface of the communication device transmits the data signal. The communication device measures a latency of the data signal between reception of the data signal at the first communication interface and transmission of the data signal by the second communication interface.

### CROSS REFERENCES TO RELATED APPLICATIONS

This application claims the benefit of U.S. Provisional Patent App. No. 63/615,537, entitled “High Precision Mechanism and Technique for Latency Measurement Through a PHY Device,” filed on Dec. 28, 2023, which is expressly incorporated herein by reference in its entirety.

### FIELD OF TECHNOLOGY

The present disclosure relates generally to network communications, and more particularly to measuring latency in a communication device.

### BACKGROUND

Clock synchronization protocols are commonly used in packet-based networks to synchronize clocks maintained at different network devices. In such clock synchronization protocols, a first network device, which maintains a master clock, otherwise referred to herein as a source clock, transmits a timing packet including a transmit timestamp generated based on a source clock time to a second network device, which maintains a slave clock, otherwise referred to herein as an endpoint clock. The second network device utilizes the transmit timestamp of the timing packet and an estimated network latency to adjust the endpoint clock in order to synchronize the endpoint clock with the source clock.

The Precision Time Protocol (PTP) is a network-based time synchronization standard that provides sub-microsecond-level synchronization. For some commercial and industrial applications, time synchronization with high accuracy is crucial, and the PTP is widely used for achieving such accuracy. For example, some applications implemented in a data center environment require multiple compute nodes to operate synchronously. In a data center, a precise, standardized time value is communicated throughout compute nodes in the data center, which permits coordinated, time-synchronized actions to be performed by the compute nodes.

As another example, the fifth generation (5G) wireless communication standard requires highly accurate timing and synchronization. In a 5G wireless communication network, a precise, standardized time value is communicated throughout the network, which permits coordinated, time-synchronized network actions, such as coordinated transmissions, cell-to-cell transfers, compensation for frequency and/or phase shifts, etc.

Different applications require different levels of clock accuracy. For telecommunication applications, the International Telecommunications Union (ITU) standard G.8273.2 defines different classes, A, B, C, and D, generally corresponding to different levels of accuracy requirements, with class D being the highest accuracy requirement. For 5G applications, class C is a mandatory requirement.

To achieve high accuracy such as required in class C and class D applications, the respective latency contributed by every component that participates in the communication of PTP packets, such as the PTP processors (e.g., the integrated circuit (IC) processor chips that reside in PTP leader and follower nodes), Ethernet physical layer (PHY) modules, optical modules, cables, backplane interfaces, etc., should be determined to facilitate compensating and/or managing overall latency.

### SUMMARY

In an embodiment, a communication device, comprises: first communication interface circuitry configured to receive a data signal that includes first alignment markers (AMs); second communication interface circuitry configured to transmit the data signal after processing by the communication device; latency measurement circuitry configured to measure a latency of the data signal between reception of the data signal at the first communication interface circuitry and transmission of the data signal by the second communication interface circuitry; processing circuitry configured to process the data signal, the processing circuitry including AM removal circuitry configured to remove the first AMs from the data signal; and AM insertion circuitry configured to insert second AMs in the data signal at locations at which the first AMs were removed from the data signal.

In another embodiment, a method for measuring latency through a communication device includes: receiving, at first communication interface circuitry of the communication device, a data signal that includes first alignment markers (AMs); determining, by the communication device, respective locations of the first AMs in the data signal; processing, by the communication device, the data signal, the processing including i) removing the first AMs from the data signal and ii) inserting second AMs in the data signal at locations at which the first AMs were removed from the data signal; transmitting, by second communication interface circuitry of the communication device, the data signal after processing by the communication device; and measuring, at the communication device, a latency of the data signal between reception of the data signal at the first communication interface circuitry and transmission of the data signal by the second communication interface circuitry.

In yet another embodiment, a communication device comprises: first communication interface circuitry configured to receive a data signal; second communication interface circuitry configured to transmit the data signal after processing by the communication device; latency measurement circuitry configured to measure a latency of the data signal between reception of the data signal at the first communication interface circuitry and transmission of the data signal by the second communication interface circuitry; rate compensation circuitry configured to one or both of i) add idle symbols to the data signal, and ii) delete idle symbols from the data signal; and latency control circuitry configured to i) detect time-sensitive packets in the data signal, and ii) selectively control the rate compensation circuitry to stop the one or both of i) the adding idle symbols to the data signal, and ii) deleting idle symbols from the data signal during processing of time-sensitive packets.

In still another embodiment, a method for measuring latency through a communication device includes: receiving, at first communication interface circuitry of the communication device, a data signal; processing, by the communication device, the data signal, the processing including rate compensation that includes one or both of i) adding idle symbols to the data signal, and ii) deleting idle symbols from the data signal; detecting, by the communication device, time-sensitive information in the data signal; selectively pausing, by the communication device, the one or both of i) the adding idle symbols to the data signal, and ii) deleting idle symbols from the data signal during processing of time-sensitive information; transmitting, by second communication interface circuitry of the communication device, the data signal after processing by the communication device; and measuring, at the communication device, a latency of the data signal between reception of the data signal at the first communication interface circuitry and transmission of the data signal by the second communication interface circuitry.

In another embodiment, a communication device comprises: first communication interface circuitry configured to receive a data signal; second communication interface circuitry configured to transmit the data signal after processing by the communication device; tracer generation circuitry configured to generate a tracer signal in connection with the first communication interface circuitry receiving the data signal; processing circuitry configured to i) process the data signal and ii) synchronously advance the tracer signal and the data signal through the communication device from the first communication interface to a second communication interface; and tracer detection circuitry configured to detect the tracer signal in connection with the second communication interface circuitry receiving the data signal; and latency measurement circuitry configured to measure a latency of the data signal through the communication device using i) a first time at which the tracer signal was generated, and ii) a second time at which the tracer signal is detected at the second communication interface circuitry by the tracer detection circuitry.

In yet another embodiment, a method for measuring latency through a communication device includes: receiving, at first communication interface circuitry of the communication device, a data signal; generating, at the communication device, a tracer signal in connection with the data signal being received at the first communication interface; synchronously advancing the tracer signal and the data signal through the communication device from the first communication interface to a second communication interface; transmitting, by the second communication interface circuitry, the data signal; and measuring, by the communication device, a latency through the communication device using i) a first time at which the tracer signal was generated and ii) a second time at which the tracer signal is detected at the second communication interface.

### BRIEF DESCRIPTION OF THE DRAWINGS

FIG. 1 is a timing diagram of an input signal received by a conventional communication device and an output signal output by the communication device.

FIG. 2 is another timing diagram of an input signal received by a conventional communication device and an output signal output by the communication device.

FIG. 3 is a simplified block diagram of an example communication device that is configured to i) receive a data signal, ii) process the data signal, iii) output the data signal, and iv) measure a latency within the communication device, according to an embodiment.

FIG. 4 is a simplified block diagram of an example system that includes the communication device of FIG. 3, according to an embodiment.

FIG. 5 is a timing diagram illustrating a data signal being processed by the communication device of FIG. 3, according to an embodiment.

FIG. 6 is a simplified block diagram of another example communication device that is configured to i) receive a data signal, ii) process the data signal, iii) output the data signal, and iv) measure a latency within the communication device, according to another embodiment.

FIG. 7 is a flow diagram of an example method for measuring a latency through a communication device, according to an embodiment.

FIG. 8 is a flow diagram of another example method for measuring a latency through a communication device, according to another embodiment.

FIG. 9 is a flow diagram of another example method for measuring a latency through a communication device, according to another embodiment.

### DETAILED DESCRIPTION

As discussed above, some systems, such as commercial systems, industrial systems, data centers, certain wireless communication networks, etc., require highly synchronized clocks distributed across a communication network. In some applications, achieving highly synchronized clocks includes measuring latency within intermediate communication devices involved in a communication link that connects nodes with respective clocks that are to be synchronized. Embodiments of techniques for measuring latency within a communication device are described below.

For example, in some embodiments described below, a communication device generates a tracer signal in connection with a data signal being received at a first communication interface of the communication device. The tracer signal indicates a reference point in the data signal in connection with measuring latency through the communication device, in an embodiment. The tracer signal and the data signal are synchronously advanced through the communication device from the first communication interface to a second communication interface, which transmits the data signal. Latency through the communication device is measured using i) a first time at which the tracer signal was generated and ii) a second time at which the tracer signal is detected at the second communication interface.

In some communication devices, such as physical layer (PHY) modules, gearboxes, and/or devices that implement forward error correction (FEC) encoding/decoding, etc., the order of data in an input data signal may be changed when the data signal is output by the communication device. For example, a data signal received by the communication device includes first alignment markers (AMs), and the communication device, as part of processing the data signal, removes the first AMs and later adds second AMs to the data signal prior to outputting the data signal, where the second AMs are at different locations in the data signal as compared to the locations of the first AMs prior to their removal, in some implementations. With conventional latency measurement techniques, the shifting of locations of the AMs by the communication device, such as described above, will result in inaccurate measurements of the latency within the communication device.

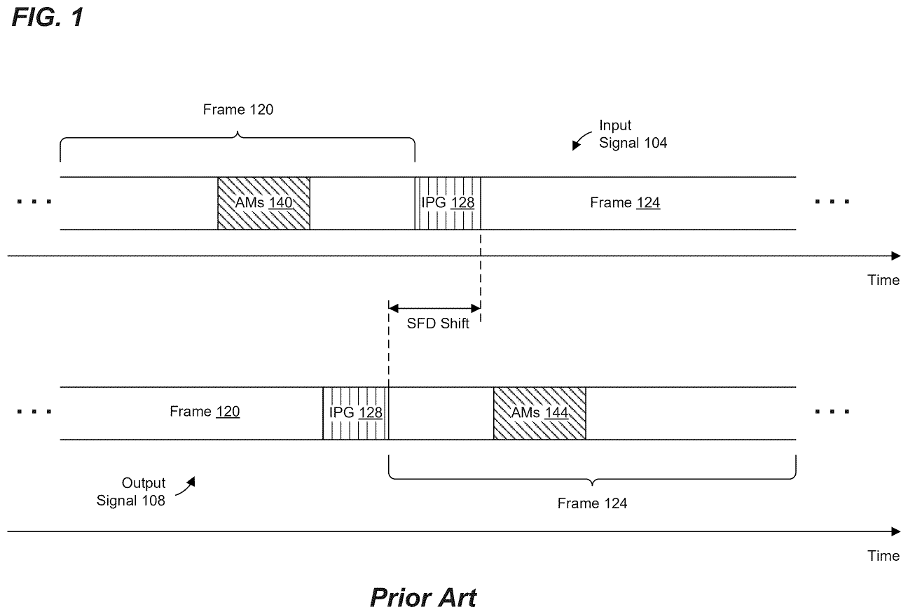

FIG. 1 is a timing diagram of an input signal 104 received by a conventional communication device and an output signal 108 output by the communication device. The input signal 104 and the output signal include a first Ethernet frame 120 followed by a second Ethernet frame 124. An interpacket gap (IPG) 128 is between the first Ethernet frame 120 and the second Ethernet frame 124.

The input signal 104 includes first alignment markers (AMs) 140 inserted within the first Ethernet frame 120. As part of processing the input signal 104, the communication device removes the first AMs 140 and subsequently inserts second AMs 124 into the output signal 108. The second AMs 144 may be inserted at a location that is different than a point at which the first AMs 140 were located in the input signal 104 prior to their removal. In the example of FIG. 1, the second AMs are added after the IPG 128, i.e., within the second Ethernet frame 124, whereas the first AMs were located before the IPG 128, i.e., within the first Ethernet frame 120. As a result, a start frame delimiter (SFD) of the second Ethernet frame 124 in the output signal 108 is shifted with respect to the SFD of the second Ethernet frame 124 in the input signal 104. Therefore, if the communication device measures latency within the communication device with reference to the SFD of the second Ethernet frame 124, the measurement will be inaccurate due to the shift of the SFD.

In some embodiments described below, a communication device, as part of processing a data signal, removes first AMs from the data signal and later inserts second AMs into the data signal at the points in the data signal at which the first AMs were located prior to removal. Because the second AMs inserted into the data signal are located at the points in the data signal at which the first AMs were located prior to removal, measurement of latency is more accurate as compared to conventional devices, at least in some implementations.

In some communication devices, such as PHY modules, gearboxes, etc., a data rate of an output signal is changed/compensated with respect to a data rate of an input signal, which involves inserting and/or deleting idle symbols into/from a data signal. With conventional latency measurement techniques, such idle symbol insertion and/or deletion by the communication device will result in inaccurate measurements of the latency within the communication device.

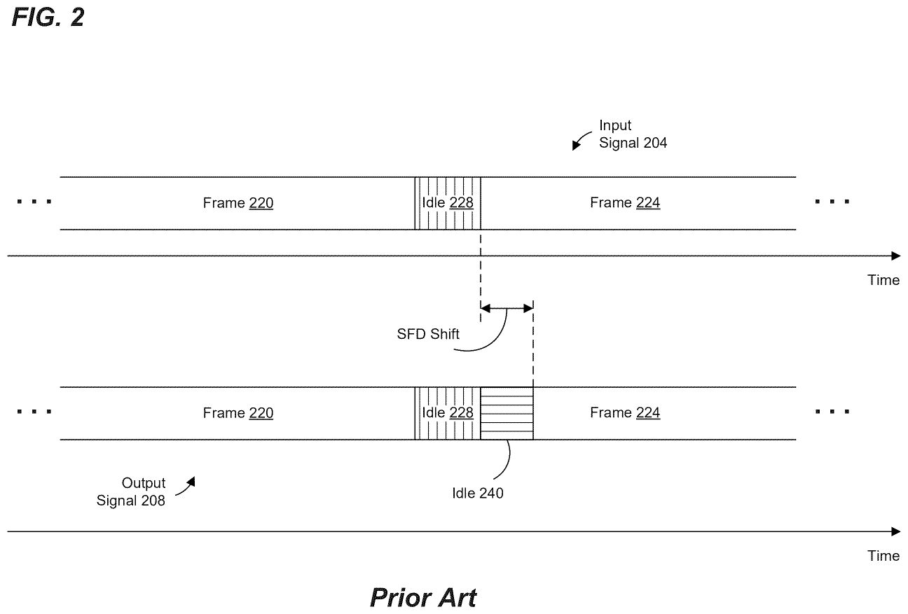

FIG. 2 is another timing diagram of an input signal 204 received by a conventional communication device and an output signal 208 output by the communication device. The input signal 204 and the output signal include a first Ethernet frame 220 followed by a second Ethernet frame 224. Idle symbols 228 are included between the first Ethernet frame 220 and the second Ethernet frame 224.

As part of processing the input signal 204, the communication device adds additional idle symbols 240 between the first Ethernet frame 220 and the second Ethernet frame 224, e.g., for rate compensation and/or rate conversion. As a result, an SFD of the second Ethernet frame 224 in the output signal 208 is shifted with respect to the SFD of the second Ethernet frame 224 in the input signal 204. Therefore, if the communication device measures latency within the communication device with reference to the SFD of the second Ethernet frame 224, the measurement will be inaccurate due to the shift of the SFD.

In some embodiments described below, a communication device monitors an incoming data signal to detect time-sensitive information in the data signal, such as PTP packets, and selectively stops insertion and/or deletion of idle symbols in connection with such time-sensitive information. Because insertion and/or deletion of idle symbols is stopped in connection with processing by the communication device of time-sensitive information, measurement of latency is more accurate as compared to conventional devices, at least in some implementations. The communication device selectively resumes insertion and/or deletion of idle symbols in connection with other information that is not time-sensitive, at least in some embodiments. The communication device resumes insertion and/or deletion of idle symbols in connection when such idle symbol insertion/deletion will not adversely affect latency measurements, at least in some embodiments.

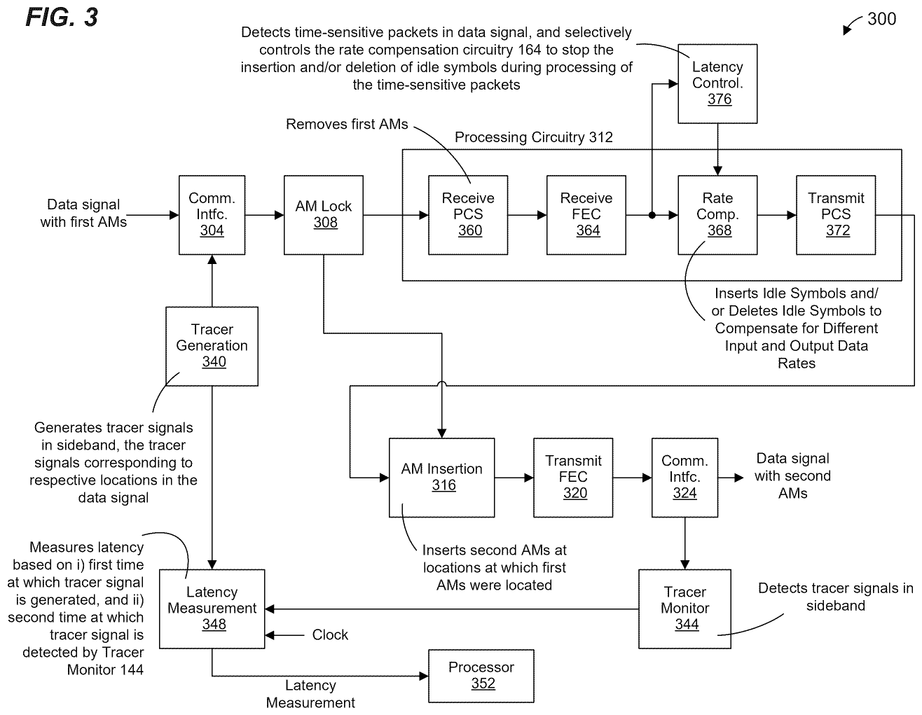

FIG. 3 is a simplified block diagram of an example communication device 300 that is configured to i) receive a data signal, ii) process the data signal, iii) output the data signal, and iv) measure a latency within the communication device 300, according to an embodiment. In some embodiments, the communication device 300 is configured to convey data signals between two other communication devices and/or communication components, e.g., between a network switch integrated circuit (IC) chip and a set of one or more cables (e.g., one or more electrical cables, one or more optical cables, etc.); between a network switch IC chip and an optical module configured to communicate via one or more optical media (e.g., optical cables, optical waveguides, free space, etc.); between a Precision Time Protocol (PTP) node (e.g., a PTP leader node, a PTP follower node, etc.) and a set of one or more cables (e.g., one or more electrical cables); between a PTP node and an optical module; etc.

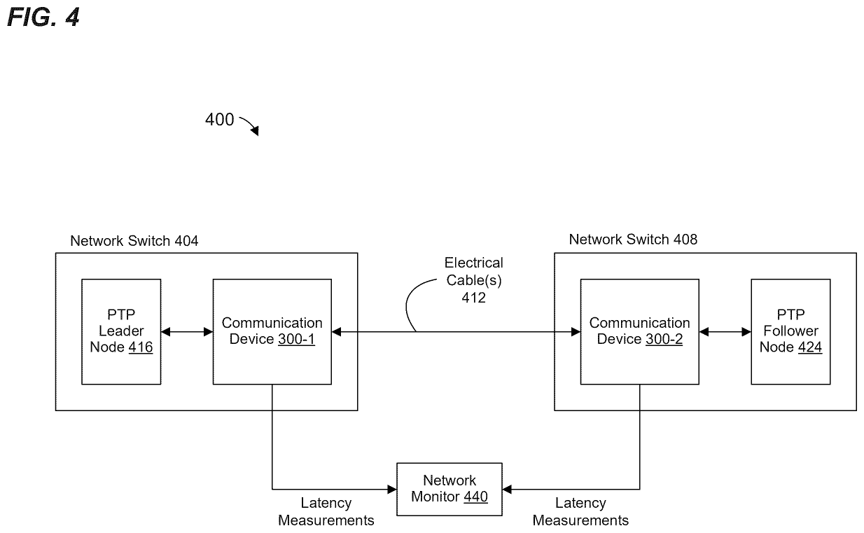

FIG. 4 is a simplified block diagram of an example system 400 that includes the communication device 300 of FIG. 3, according to an embodiment. The system 400 includes a network switch 404 communicatively coupled to a network switch 408 via one or more electrical cables 412. The network switch 404 includes a PTP leader node 416 that is configured to perform PTP leader operations defined by the PTP. In an embodiment, the PTP leader node 416 comprises a processor, e.g., a processor that executes machine-readable instructions stored in a memory (not shown) coupled to the processor, the machine readable instructions, when executed by the processor, causing the processor to perform PTP leader operations defined by the PTP. In another embodiment, the PTP leader node 404 additionally or alternatively comprises a processor having a hardware state machine that is configured to cause the processor to perform PTP leader operations defined by the PTP.

The PTP leader node 416 is coupled to a first instance of the communication device 300, i.e., the communication device 300-1. The communication device 300-1 conveys data signals between the PTP leader node 416 and the one or more cables 412.

In an embodiment, such as an embodiment in which the PTP leader node 416 and the communication device 300-1 are located on a single printed circuit board (PCB), the PTP leader node 416 is coupled to the communication device 300-1 via a serial interface. In an embodiment, the serial interface comprises a plurality of lanes.

In another embodiment, such as an embodiment in which the PTP leader node 416 and the communication device 300-1 are located on different PCBs, the PTP leader node 416 is coupled to the communication device 300-1 via a fabric interface.

The network switch 408 includes a PTP follower node 424 that is configured to perform PTP follower operations defined by the PTP. In an embodiment, the PTP follower node 424 comprises a processor, e.g., a processor that executes machine-readable instructions stored in a memory (not shown) coupled to the processor, the machine readable instructions, when executed by the processor, causing the processor to perform PTP follower operations defined by the PTP. In another embodiment, the PTP follower node 424 additionally or alternatively comprises a processor having a hardware state machine that is configured to cause the processor to perform PTP follower operations defined by the PTP.

The PTP follower node 424 is coupled to a second instance of the communication device 300, i.e., the communication device 300-2. The communication device 300-2 conveys data signals between the PTP follower node 424 and the one or more cables 412.

In an embodiment, such as an embodiment in which the PTP follower node 424 and the communication device 300-2 are located on a single PCB, the PTP follower node 424 is coupled to the communication device 300-2 via a serial interface. In an embodiment, the serial interface comprises a plurality of lanes.

In another embodiment, such as an embodiment in which the PTP follower node 424 and the communication device 300-2 are located on different PCBs, the PTP follower node 424 is coupled to the communication device 300-2 via a fabric interface.

In some embodiments in which the cable(s) 412 are replaced by one or more optical media (e.g., optical cable(s), optical waveguide(s), free space, etc.), the network switch 404 includes one or more optical modules between the communication device 300-1 and the one or more optical media, the optical module(s) communicatively coupling the communication device 300-1 to the one or more optical media; and the network switch 408 includes one or more optical modules between the communication device 300-2 and the one or more optical media, the optical module(s) communicatively coupling the communication device 300-2 to the one or more optical media.

Although the network switch 404 is illustrated as having one communication device 300-1, the network switch 404 includes one or more other communication devices 300 (not shown) coupled to one or more other cables (not shown), in other embodiments. Similarly, although the network switch 408 is illustrated as having one communication device 300-2, the network switch 408 includes one or more other communication devices 300 (not shown) coupled to one or more other cables (not shown), in other embodiments.

In other embodiments, the PTP leader node 416 and the communication device 300-1 are included in an endpoint device, such as a network server. Similarly, in other embodiments, the PTP follower node 424 and the communication device 300-2 are included in an endpoint device, such as a network server.

In other embodiments, the communication device 300 is included in another suitable system different than the system 400 of FIG. 4.

Referring again to FIG. 3, the communication device 300 includes a communication interface 304 that is configured to receive a data signal. In an embodiment, the communication interface 304 is configured to receive the data signal via a serial communication link. In some embodiments in which the communication interface 304 is configured to receive the data signal via a serial communication link, the communication interface 304 includes a serializer/deserializer (SERDES).

In an embodiment, the communication interface 304 is configured to receive the data signal via a plurality of lanes corresponding to a plurality of electrical links, a plurality of optical waveguides, a plurality of optical cables, etc. In an embodiment, the communication interface 304 is configured to receive the data signal via a media independent interface (MII). In an embodiment, the communication interface 304 is configured to receive the data signal via a communication fabric, such as an Ethernet fabric, a Fibre Channel fabric, an Infiniband fabric, etc.

In an embodiment, the communication interface 304 is configured to receive the data signal via an electrical cable. In another embodiment, the communication interface 304 is configured to receive the data signal via an optical receiver coupled to an optical medium (e.g., an optical cable, an optical waveguide, free space, etc.).

In an embodiment, the data signal received by the communication interface 304 includes alignment markers (AMs), sometimes referred to herein as “first AMs.” In an embodiment, the first AMs correspond to AMs specified by the Institute for Electrical and Electronics Engineers (IEEE) standard 802.3. In other embodiments, the first AMs correspond to other suitable communication protocols, such as the Infiniband communication protocol, the Peripheral Component Interconnect Express (PCIe) communication protocol, etc. AMs are recurring symbols and/or patterns in the data signal that can be used for realigning or deskewing data streams received via a plurality of signal paths or lanes, where the data signal is received via the plurality of lanes, at least in some embodiments.

In some embodiments, the communication device 300 includes AM lock circuitry 308 that is configured to achieve lock with respect to the first AMs. In an embodiment in which the communication interface 304 is configured to receive the data signal via a plurality of lanes, the AM lock circuitry 308 is also configured to, after achieving lock with respect to the first AMs, reorder transmission symbols received via the plurality of lanes to account for skewing of the transmission symbols across the plurality of lanes.

The communication device 300 also includes processing circuitry 312 that is configured to process the data signal for retransmission by the communication device 300. For example, the processing circuitry 312 is configured to perform receive-side physical coding sublayer (PCS) protocol operations with respect to data that are received via the communication interface 304, in an embodiment. Additionally or alternatively, the processing circuitry 312 is configured to perform forward error correction (FEC) decoding operations with respect to data that are received via the communication interface 304, in an embodiment. Additionally or alternatively, the processing circuitry 312 is configured to perform data rate compensation/conversation operations with respect to data that are received via the communication interface 304, in an embodiment.

In some embodiments in which the data signal received via the communication interface 304 includes first AMs, the processing circuitry 312 is configured to remove the first AMs. At least in embodiments in which the processing circuitry 312 is configured to remove the first AMs, the communication device 300 includes AM insertion circuitry 316 that is configured to insert AMs (sometimes referred to herein as “second AMs”) in the data signal. As will be described further below, the AM insertion circuitry 316 is configured to insert the second AMs at locations in the data signal corresponding to points in the data signal at which the first AMs were located prior to removal of the first AMs by the communication device 300, in some embodiments.

At least in embodiments in which the processing circuitry 312 is configured to perform FEC decoding operations with respect to data that are received via the communication interface 304, the communication device 300 includes transmit FEC encoding circuitry 320 that is configured to implement an FEC encoder that encodes, according to an FEC code, data for transmission by the communication device 300.

The communication device 300 also includes a communication interface 324 that is configured to transmit the data signal after processing of the data signal by the processing circuitry 312 and other circuitry of the communication device 300 described above. In an embodiment, the communication interface 324 is configured to generate, based on the data signal, a transmit signal for transmission via an electrical cable. In another embodiment, the communication interface 324 is configured to generate, based on the data signal, a drive signal for driving an optical transmitter coupled to an optical cable.

In an embodiment, the communication interface 324 is configured to transmit the data signal via a serial communication link. In some embodiments in which the communication interface 324 is configured to transmit the data signal via a serial communication link, the communication interface 324 includes a SERDES.

In an embodiment, the communication interface 324 is configured to transmit the data signal via a plurality of lanes corresponding to a plurality of electrical links, a plurality of optical waveguides, a plurality of optical cables, etc. In an embodiment, the communication interface 324 is configured to transmit the data signal via an MII. In an embodiment, the communication interface 304 is configured to transmit the data signal via a communication fabric, such as an Ethernet fabric, a Fibre Channel fabric, an Infiniband fabric, etc.

In an embodiment, the communication interface 324 is configured to transmit the data signal via an electrical cable. In another embodiment, the communication interface 324 is configured to transmit the data signal via an optical transceiver coupled to an optical medium (e.g., an optical cable, an optical waveguide, free space, etc.).

Tracer generation circuitry 340 is coupled to the communication interface 304. The tracer generation circuitry 340 is configured to selectively generate a tracer signal that provides a reference point in the data signal. In an embodiment, the tracer signal is a sideband signal that synchronously advances with the data signal as the data signal is processed by the communication device 300. For example, in an embodiment, the data signal the data signal is output by the communication interface 304 as a parallel signal having a suitable bit width, and the sideband signal corresponds to one or more sideband bits appended to, or otherwise associated with, data bits of the parallel signal. In such an embodiment, the data bits and the sideband bit(s) are synchronously clocked through the communication device from the communication interface 304 to the communication interface 324 so that the tracer signal synchronously advances with the data signal as the data signal is processed by the communication device 300.

Tracer monitor circuitry 344 is coupled to the communication interface 324 and is configured to detect the tracer signal when the tracer signal is present at the communication interface 324. A time duration between a first time at which the tracer signal is generated by the tracer generation circuitry 340 and a second time at which the tracer signal is detected by the tracer monitor circuitry 344 provides a measure of a latency caused by the communication device 300. Thus, a latency measurement unit 348 is configured to use the first time at which the tracer signal is generated by the tracer generation circuitry 340 and the second time at which the tracer signal is detected by the tracer monitor circuitry 344 to generate a measure of the latency. The latency measurement unit 348 receives a clock signal that provides a time reference, and the latency measurement unit 348 records the first time in response to receiving a signal from the tracer generation circuitry 340 that indicates the tracer signal was generated by the tracer generation circuitry 340; similarly the latency measurement unit 348 records the second time in response to receiving a signal from the tracer monitoring circuitry 344 that indicates the tracer signal was detected by the tracer monitoring circuitry 344, according to an embodiment.

The latency measurement unit 348 is configured to also use other information, in addition to the first time and the second time, to generate the measure of the latency, in other embodiments. For example, the latency measurement unit 348 also uses one or both of i) an indication of a fixed and/or deterministic latency regarding the communication interface 304, and ii) an indication of a fixed and/or deterministic latency regarding the communication interface 324 to generate the measure of the latency, in another embodiment.

The latency measurement unit 348 is implemented at least by a processor (not shown) executing machine-readable instructions stored in a memory (not shown), the machine-readable instructions, when executed by the processor, causing the processor to perform operations associated with using the first time and the second time to generate a measure of the latency, according to an embodiment. Additionally or alternatively, the latency measurement unit 348 is implemented at least by hardware circuitry that is configured to perform operations associated with using the first time and the second time to generate a measure of the latency, according to another embodiment.

The latency measurement unit 348 provides latency measurements generated by the latency measurement unit 348 to a processor 352. In an embodiment, the processor 352 is a component of the communication device 300, such as a host processor of the communication device 300. In other embodiments, the processor 352 is external to the communication device 300. For example, the processor 352 corresponds to the PTP leader node 416, in an embodiment. In another embodiment, the processor 352 corresponds to the PTP follower node 424. In another embodiment, the processor 352 corresponds to a network monitor unit 440 (FIG. 4) that receives latency measurements from multiple communication devices (e.g., the communication devices 300) in a communication network.

The processor 352 is implemented at least by a processor (not shown) executing machine-readable instructions stored in a memory (not shown), the machine-readable instructions, when executed by the processor, causing the processor to perform operations associated with receiving latency measurements and using the latency measurements to perform suitable operations such as one or more of PTP protocol-related operations, synchronizing generating measurements of overall latencies along paths through a communication network, etc., according to an embodiment.

Referring again to FIG. 4, the network monitor 440 is omitted and/or the communication devices 300 do not provide latency measurements to the network monitor 440, in some embodiments.

Referring again to FIG. 3, the processing circuitry 312 includes receive PCS circuitry 360 that is configured to perform PCS sublayer protocol operations with respect to data that are received via the communication interface 304, in an embodiment. For example, the receive PCS circuitry 360 includes decoding circuitry that decodes an encoded block of bits (e.g., 81 bits) received via the communication interface 304 to generate a decoded block of bits (e.g., 80 bits), according to an embodiment.

The processing circuitry 312 also includes receive FEC decoding circuitry 364 that is configured to implement an FEC decoder that decodes, according to an FEC code, data received via the communication interface 304.

The processing circuitry 312 also includes rate compensation circuitry 368 that is configured to perform rate change and/or rate compensation operations to change a data rate of the data signal so that the data signal is output by the communication device at a data rate that is different than a data rate at which the data signal was received by the communication device 300, according to an embodiment. The rate compensation circuitry 368 is configured to insert and/or delete idle symbols into/from the data signal as part of the rate change and/or rate compensation operations, according to an embodiment. The rate compensation circuitry 368 is configured to insert and/or delete idle symbols into/from IPGs in the data signal, according to an embodiment. The rate compensation circuitry 368 is configured to insert and/or delete idle symbols into/from locations in the data signal outside of IPGs, according to another embodiment.

The processing circuitry 312 also includes transmit PCS circuitry 372 that is configured to perform PCS sublayer protocol operations with respect to data that are to be transmitted via the communication interface 324, in an embodiment. For example, the transmit PCS circuitry 372 includes encoding circuitry that encodes a block of bits (e.g., 80 bits) to generate an encoded block of bits (e.g., 81 bits) to be transmitted via the communication interface 324, according to an embodiment.

As discussed above, the AM lock circuitry 308 achieves lock with respect to the first AMs in the data signal received via the communication interface 304. In an embodiment, the AM lock circuitry 308 is also configured to generate indications of locations of the first AMs in the data signal. In an embodiment, the indications of locations of the first AMs in the data signal include respective offsets to reference points in the data signal.

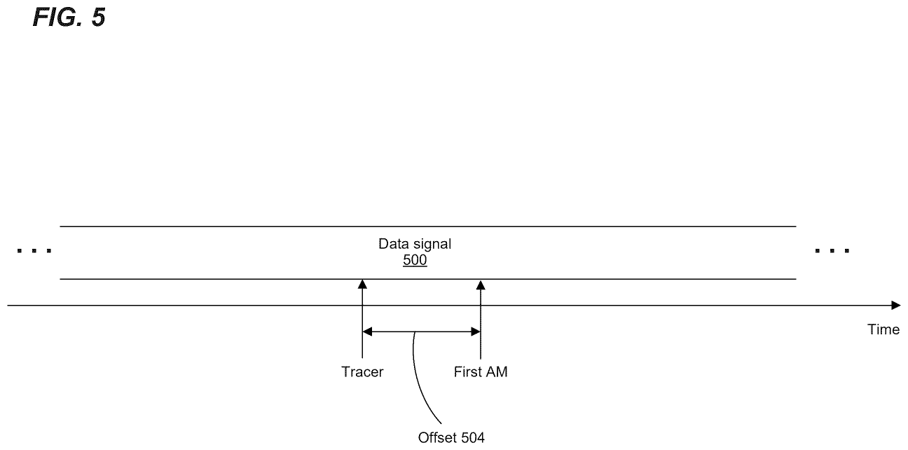

In an embodiment, the indications of locations of the first AMs in the data signal include respective offsets to locations of tracer signals generated by the tracer generation circuitry 340. FIG. 5 is a timing diagram illustrating a data signal 500 being processed by the communication device 300, according to an embodiment. The AM lock circuitry 308 generates an indication of an offset 504 between a location of a first AM and a tracer signal, according to an embodiment.

The AM insertion circuitry 316 is coupled to the AM lock circuitry 308 and receives indications of locations of the first AMs from the AM lock circuitry 308. The AM insertion circuitry 316 is configured to insert the second AMs at locations in the data signal determined using the indications of locations of the first AMs from the AM lock circuitry 308, in an embodiment. In an embodiment in which the indications of locations of the first AMs include respective offsets to locations of tracer signals generated by the tracer generation circuitry 340, the AM insertion circuitry 316 inserts the second AMs at locations in the data signal determined using tracer signals and offsets generated by the tracer generation circuitry 340.

Referring again to FIG. 3, the communication device 300 also includes a latency controller 376 that is coupled to the rate compensation circuitry 368. The latency controller 376 is configured to i) detect when the data signal includes time-sensitive information, and ii) selectively control the rate compensation circuitry 368 to pause the insertion/deletion of idle symbols in connection with the time-sensitive information. In an embodiment, the latency controller 376 is configured to i) detect PTP packet in the data signal, and ii) selectively control the rate compensation circuitry 368 to pause the insertion/deletion of idle symbols in connection with the PTP packet.

The latency controller 376 is implemented at least by a processor (not shown) executing machine-readable instructions stored in a memory (not shown), the machine-readable instructions, when executed by the processor, causing the processor to perform operations associated with i) detecting when the data signal includes time-sensitive information, and/or ii) selectively controlling the rate compensation circuitry 368 to pause the insertion/deletion of idle symbols in connection with the time-sensitive information, according to an embodiment. Additionally or alternatively, the latency controller 376 is implemented at least by hardware circuitry that is configured to perform operations associated with i) detecting when the data signal includes time-sensitive information, and/or ii) selectively controlling the rate compensation circuitry 368 to pause the insertion/deletion of idle symbols in connection with the time-sensitive information, according to another embodiment.

Referring again to the AM lock circuitry 308, the AM lock circuitry 308 is configured to generate indications offsets between first AMs and locations of tracer signals generated by the tracer generation circuitry 340. In another embodiment, the AM lock circuitry 308 is also configured to shift a tracer signal generated by the tracer generation circuitry 340 to align with a first AM, and the AM insertion circuitry 316 is configured to use the tracer signal to determine a locations at which to insert the second AM so that the second AM is located at the point at which the first AM was located prior to first AM being removed. In some such embodiments, the offsets generated by the AM lock circuitry 308 correspond to an amount by which respective tracer signals were shifted. In some such embodiments, the AM lock circuitry 308 is coupled to the latency measurement unit 348 and provides to the latency measurement unit 348 the offsets; and the latency measurement unit 348 is configured to generate the measure of the latency using i) the first time at which the tracer signal is generated by the tracer generation circuitry 340, ii) the second time at which the tracer signal is detected by the tracer monitor circuitry 344, and iii) the offset.

In another embodiment, the tracer generation circuitry 340 is configured to generate tracer signals that are aligned with locations of the first AMs in the data signal, and the AM insertion circuitry 316 is configured to use the tracer signals to determine locations at which to insert the second AMs. In some such embodiments, the AM lock circuitry 308 is not coupled to the AM insertion circuitry 316 and does not generate indications of locations at which the first AMs were located in the data signal.

In some embodiments, the communication device 300 is configurable to selectively bypass one or more components of the communication device, and/or to selectively configure one or more components in a pass-through mode in which the data signal passes through a component essentially unmodified. For example, when an application does not require data rate conversion/compensation performed by the rate compensation circuitry 368, the processing circuitry 312 is configurable so that the data signal bypasses the rate compensation circuitry 368 and/or the rate compensation circuitry 368 is configurable to operate in a pass-through mode in which the data signal passes through the rate compensation circuitry 368 essentially unmodified, according to an embodiment.

As another example, when an application does not require FEC decoding performed by the receive FEC circuitry 364, the processing circuitry 312 is configurable so that the data signal bypasses the receive FEC circuitry 364 and/or the receive FEC circuitry 364 is configurable to operate in a pass-through mode in which the data signal passes through the receive FEC circuitry 364 essentially unmodified, according to an embodiment.

As another example, when an application does not require FEC encoding performed by the transmit FEC circuitry 320, the communication device 300 is configurable so that the data signal bypasses the transmit FEC circuitry 320 and/or the transmit FEC circuitry 320 is configurable to operate in a pass-through mode in which the data signal passes through the transmit FEC circuitry 320 essentially unmodified, according to an embodiment.

As another example, when an application does not require PCS processing performed by the receive PCS circuitry 360, the processing circuitry 312 is configurable so that the data signal bypasses the receive PCS circuitry 360 and/or the receive PCS circuitry 360 is configurable to operate in a pass-through mode in which the data signal passes through the receive PCS circuitry 360 essentially unmodified, according to an embodiment.

As another example, when an application does not require AM removal, the receive PCS circuitry 360 is configurable so that the data signal bypasses circuitry that removes AMs and/or the circuitry that removes AMs is configurable to operate in a pass-through mode in which the data signal passes through essentially unmodified, according to an embodiment.

As another example, when an application does not require PCS processing performed by the transmit PCS circuitry 372, the processing circuitry 312 is configurable so that the data signal bypasses the transmit PCS circuitry 372 and/or the transmit PCS circuitry 372 is configurable to operate in a pass-through mode in which the data signal passes through the transmit PCS circuitry 372 essentially unmodified, according to an embodiment.

As another example, when an application does not require deskewing performed by the AM lock circuitry 308, the communication device 300 is configurable so that the data signal bypasses the AM lock circuitry 308 and/or the AM lock circuitry 308 is configurable to operate in a pass-through mode in which the data signal passes through the AM lock circuitry 308 essentially unmodified, according to an embodiment.

As another example, when an application does not require AM insertion performed by the AM insertion circuitry 360, the communication device 300 is configurable so that the data signal bypasses the AM insertion circuitry 360 and/or the AM insertion circuitry 360 is configurable to operate in a pass-through mode in which the data signal passes through the AM insertion circuitry 360 essentially unmodified, according to an embodiment.

In other embodiments, the communication device 300 includes other suitable circuitry not shown in FIG. 3 and/or omits various circuitry illustrated in FIG. 3 and/or is otherwise modified in a suitable manner. For example, the communication device 300 omits the latency controller 376, in an embodiment. In another embodiment, the communication device 300 omits the rate compensation circuitry 368 and the latency controller 376. Additionally or alternatively, the receive FEC circuitry 364 and/or the transmit FEC circuitry 320 are omitted, in another embodiment. Additionally or alternatively, the AM lock circuitry 308 is omitted, in another embodiment. Additionally or alternatively, the AM insertion circuitry 316 is omitted, in another embodiment. Additionally or alternatively, the receive PCS circuitry 360 and/or the transmit PCS circuitry 320 are omitted, in another embodiment. In another embodiment, the AM insertion circuitry 316 does not insert the second AMs at locations corresponding to points at which the first AMs were located prior to removal. In another embodiment, the receive PCS circuitry 360 does not remove AMs.

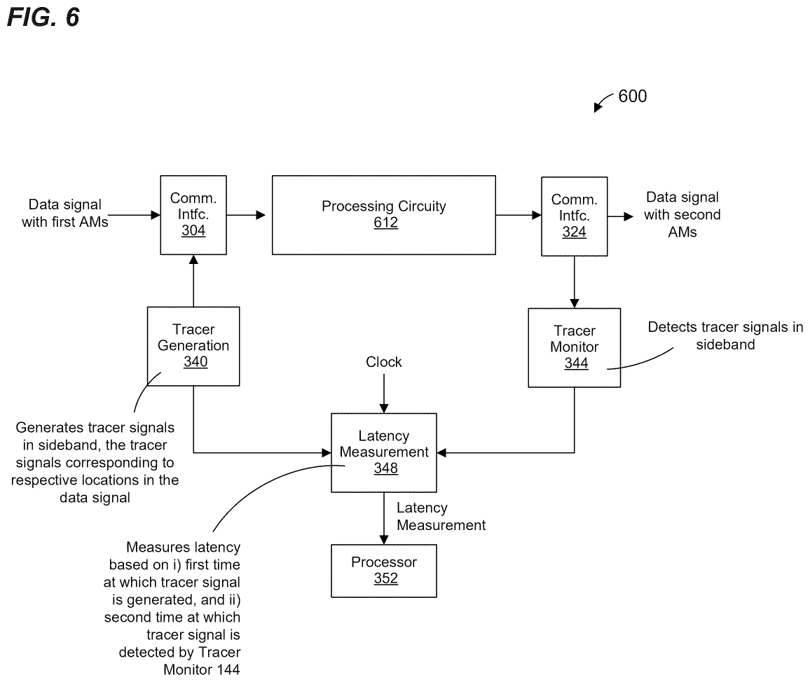

FIG. 6 is a simplified block diagram of another example communication device 600 that is configured to i) receive a data signal, ii) process the data signal, iii) output the data signal, and iv) measure a latency within the communication device 600, according to another embodiment. The communication device 600 is similar to the communication device 300 of FIG. 3, and like-numbered elements are not described again in detail for purposes of brevity.

In some embodiments, the communication device 600 is configured to convey data signals between two other communication devices and/or communication components, e.g., between a network switch IC chip and a set of one or more cables (e.g., one or more electrical cables); between a network switch IC chip and an optical module configured to communicate via one or more optical media (e.g., optical cables, optical waveguides, free space, etc.); between a PTP node (e.g., a PTP leader node, a PTP follower node, etc.) and a set of one or more cables (e.g., one or more electrical cables, a set of one or more optical cables, etc.); between a PTP node and an optical module; etc.

In an embodiment, the communication device 600 replaces the communication device 300 in the system 400 of FIG. 4. In another embodiment, the communication device 600 is included in another suitable system different than the system 400 of FIG. 4.

The communication device 600 includes processing circuitry 612 that processes the data signal that is received via the communication interface 304 in a suitable manner. For example, in an embodiment in which the data signal is received by the communication interface 304 via a plurality of lanes, the processing circuitry 612 is configured to achieve lock to AMs in the data signal. In another embodiment in which the data signal is received by the communication interface 304 via a plurality of lanes, the processing circuitry 612 is additionally or alternatively configured to perform a deskewing operation on the data signal.

In an embodiment, the communication devices 600 does not remove AMs from or add AMs to the data signal. In another embodiment, the communication devices 600 additionally or alternatively does not remove idle symbols from or add idle symbols to the data signal.

The tracer generation circuitry 340, the tracer monitor circuitry 344, and the latency measurement unit 348 operate as described above with reference to FIG. 3, in an embodiment.

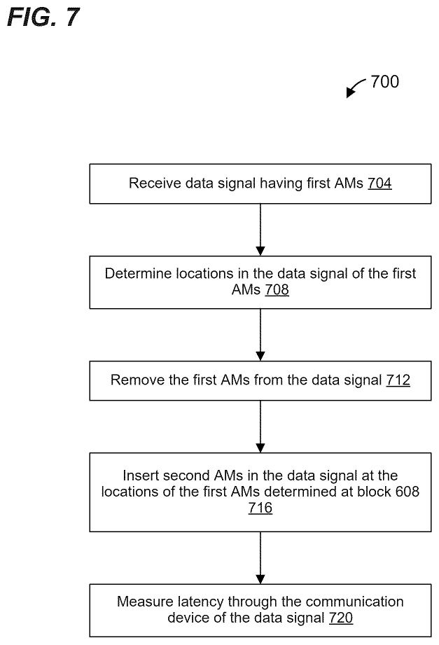

FIG. 7 is a flow diagram of an example method 700 for measuring a latency through a communication device, according to an embodiment. The method 700 is implemented by the communication device 300 of FIG. 3, according to an embodiment, and the method 700 is described with reference to FIG. 3 for ease of explanation. In other embodiments, the method 700 is implemented by another suitable communication device. Additionally, the communication device 300 implements another suitable method for measuring latency different than the method 700, in some embodiments.

At block 704, the communication device receives a data signal that includes first AMs. For example, the communication interface 304 receives the data signal.

At block 708, the communication device determines respective locations of the first AMs within the data signal. For example, the AM lock circuitry 308 determines respective locations of the first AMs within the data signal, in some embodiments. In an embodiment, the tracer generation circuitry 340 generates tracer signals, and the AM lock circuitry 308 determines respective offsets between locations of the first AMs within the data signal and corresponding tracer signals. In another embodiment, the tracer generation circuitry 340 generates tracer signals, and the AM lock circuitry 308 i) determines respective offsets between locations of the first AMs within the data signal and corresponding tracer signals, and ii) shifts the tracer signals to correspond with locations of the first AMs within the data signal. In another embodiment, the tracer generation circuitry 340 determines respective locations of the first AMs within the data signal and generates respective tracer signals that coincide with the respective locations of the first AMs.

At block 712, the communication device removes the first AMs from the data signal. For example, the processing circuitry 312 removes the first AMs. In an embodiment, the receive PCS circuitry 360 removes the first AMs.

At block 716, the communication device inserts second AMs in the data signal at the determined locations of the first AMs that were removed from the data signal. For example, the AM insertion circuitry 316 inserts the second AMs in the data signal at the determined locations of the first AMs.

At block 720, the communication device measures a latency through the communication device. For example, the latency measurement unit 348 measures a latency through the communication device 300. Measuring the latency at block 720 comprises i) generating a tracer signal at a first time, the tracer signal corresponding to a reference point in the data signal, ii) moving the tracer signal along with the data signal so that the tracer signal is synchronized with the reference point in the data signal, and iii) detecting the tracer signal at a second time that corresponds to the reference point of the data signal being output by the communication device.

In an embodiment, inserting the second AMs (block 716) at points in the data signal at which the first AMs were located prior to removal improves accuracy of the measured latency as compared to a scenario in which the second AMs are inserted in the data signal at other locations different from the locations at which the first AMs were located.

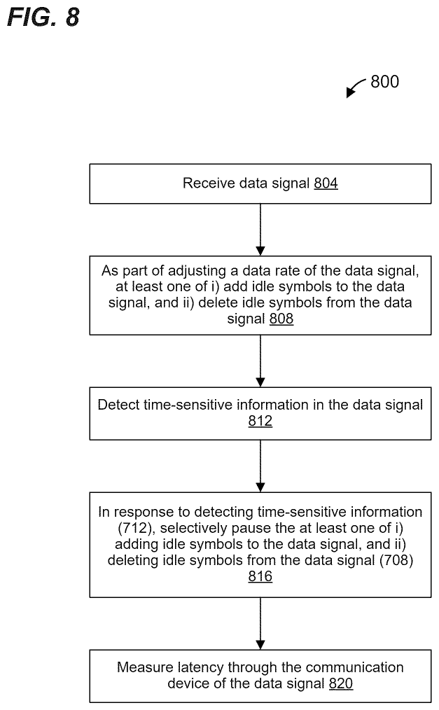

FIG. 8 is a flow diagram of another example method 800 for measuring a latency through a communication device, according to another embodiment. The method 800 is implemented by the communication device 300 of FIG. 3, according to an embodiment, and the method 800 is described with reference to FIG. 3 for ease of explanation. In other embodiments, the method 800 is implemented by another suitable communication device. Additionally, the communication device 300 implements another suitable method for measuring latency different than the method 800, in some embodiments.

In an embodiment, the method 800 is combined with the method 700, i.e., the communication device that implements the method 800 also implements the method 700. In other embodiments, the method 800 is not combined with the method 700, and the communication device that implements the method 800 does not implement the method 700.

At block 804, the communication device receives a data signal. For example, the communication interface 304 receives the data signal.

At block 808, the communication device at least one of i) adds idle symbols to the data signal, and ii) deletes idle symbols from the data signal to adjust a data rate of the data signal when output by the communication device. For example, the rate compensation circuitry 368 at least one of i) adds idle symbols to the data signal, and ii) deletes idle symbols from the data signal to adjust a data rate of the data signal when output by the communication device 300.

At block 812, the communication device detects time-sensitive information in the data signal. For example, the latency controller 376 detects time-sensitive information in the data signal. Detecting time-sensitive information at block 812 comprises detecting PTP packets, in an embodiment.

At block 816, the communication device, in response to detecting time-sensitive information at block 812, selectively pauses the at least one of i) adding idle symbols to the data signal, and ii) deleting idle symbols from the data signal. For example, the latency controller 376, in response to detecting time-sensitive information in the data signal, controls the rate compensation circuitry 368 to pause the at least one of i) adding idle symbols to the data signal, and ii) deleting idle symbols from the data signal. In an embodiment, the communication device selectively pauses the at least one of i) adding idle symbols to the data signal, and ii) deleting idle symbols from the data signal at least while the communication device is processing the time-sensitive information.

At block 820, the communication device measures a latency through the communication device. For example, the latency measurement unit 348 measures a latency through the communication device 300. Measuring the latency at block 820 comprises i) generating a tracer signal at a first time, the tracer signal corresponding to a reference point in the data signal, ii) moving the tracer signal along with the data signal so that the tracer signal is synchronized with the reference point in the data signal, and iii) detecting the tracer signal at a second time that corresponds to the reference point of the data signal being output by the communication device. In an embodiment, measuring the latency through the communication device at block 820 comprises measuring the latency in connection with processing the time-sensitive information in the data signal.

In an embodiment, selectively pausing the at least one of i) adding idle symbols to the data signal, and ii) deleting idle symbols from the data signal (block 816) improves accuracy of the measured latency as compared to a scenario in which the at least one of i) adding idle symbols to the data signal, and ii) deleting idle symbols from the data signal is not paused during the processing of the time-sensitive information.

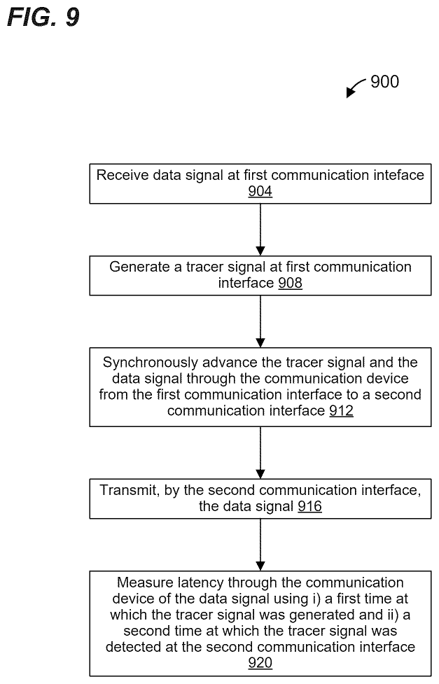

FIG. 9 is a flow diagram of another example method 900 for measuring a latency through a communication device, according to another embodiment. The method 900 is implemented by the communication device 300 of FIG. 3, according to an embodiment. The method 900 is implemented by the communication device 600 of FIG. 6, according to another embodiment. In other embodiments, the method 900 is implemented by another suitable communication device. Additionally, the communication device 300 and the communication device 600 implement another suitable method for measuring latency different than the method 900, in some embodiments.

The method 900 is described with reference to FIGS. 3 and 6 for ease of explanation.

In an embodiment, the method 900 is combined with the method 700 and/or the method 800, i.e., the communication device that implements the method 900 also implements the method 700 and/or the method 800. In other embodiments, the method 900 is not combined with the method 700 nor the method 800, and the communication device that implements the method 900 does not implement the method 700 nor the method 800.

At block 904, the communication device receives a data signal at a first communication interface. For example, the communication interface 304 receives the data signal.

At block 908, the communication device generates a tracer signal in connection with the data signal being received at the first communication interface. For example, the tracer generation circuitry 340 generates the tracer signal. In an embodiment, the tracer signal is generated by the first communication interface as a sideband signal that advances in parallel with the data signal through the communication device. In an embodiment, the data signal is output by the first communication interface as a parallel signal having a suitable bit width, and the sideband signal corresponds to one or more sideband bits appended to, or otherwise associated with, data bits of the parallel signal.

At block 912, the communication device synchronously advances the tracer signal and the data signal through the communication device from the first communication interface to a second communication interface. For example, in an embodiment in which the data signal is output by the first communication interface as a parallel signal having a suitable bit width and the sideband signal corresponds to one or more sideband bits appended to, or otherwise associated with, data bits of the parallel signal, the communication device clocks the parallel signal and the sideband bit(s) synchronously through the communication device from the first communication interface to the second communication interface so that the tracer signal synchronously advances with the data signal as the data signal is processed by the communication device.

In an embodiment, synchronously advancing the tracer signal and the data signal at block 912 includes the processing circuitry 312 synchronously advancing the tracer signal and the data signal. In another embodiment, synchronously advancing the tracer signal and the data signal at block 912 includes the processing circuitry 612 synchronously advancing the tracer signal and the data signal.

At block 916, the second communication interface transmits the data signal. For example, the communication interface 324 transmits the data signal.

At block 920, the communication device measures a latency through the communication device. For example, the latency measurement unit 348 measures a latency through the communication device 300/600. Measuring the latency at block 920 comprises using i) a first time at which the tracer signal was generated and ii) a second time at which the tracer signal is detected at the second communication interface, according to an embodiment.

Embodiment 1: A communication device, comprising: first communication interface circuitry configured to receive a data signal that includes first alignment markers (AMs); second communication interface circuitry configured to transmit the data signal after processing by the communication device; latency measurement circuitry configured to measure a latency of the data signal between reception of the data signal at the first communication interface circuitry and transmission of the data signal by the second communication interface circuitry; processing circuitry configured to process the data signal, the processing circuitry including AM removal circuitry configured to remove the first AMs from the data signal; and AM insertion circuitry configured to insert second AMs in the data signal at locations at which the first AMs were removed from the data signal.

Embodiment 2: The communication device of embodiment 1, wherein the insertion of the second AMs in the data signal at the locations at which the first AMs were removed from the data signal improves accuracy in measured latency measured by the latency measurement circuitry as compared to a scenario in which the second AMs are inserted in the data signal at other locations different from the locations at which the first AMs were removed from the data signal.

Embodiment 3: The communication device of either of embodiments 1 or 2, further comprising: tracer generation circuitry coupled to the first communication interface circuitry, the tracer generation circuitry configured to generate, at a first time, a tracer signal in a sideband that is synchronized with the data signal; and tracer monitoring circuitry coupled to the second communication interface circuitry, the tracer monitoring circuitry configured to detect the tracer signal at the second communication interface at a second time; wherein latency measurement circuitry is configured to measure the latency responsively to the first time and the second time.

Embodiment 4: The communication device of any of embodiments 1-3, further comprising: circuitry configured to i) detect the locations of the first AMs in the data signal, and ii) provide indications of the locations of the first AMs to the AM insertion circuitry; wherein the AM insertion circuitry is configured to use the indications of the locations of the first AMs to insert the second AMs in the data signal at the locations at which the first AMs were removed from the data signal.

Embodiment 5: The communication device of embodiment 4, wherein: the circuitry configured to provide the indications of the locations of the first AMs to the AM insertion circuitry is configured to generate the indications of the locations of the first AMs to include respective offsets between respective locations of the first AMs and respective reference points in the data signal; and the AM insertion circuitry is configured to use the respective offsets to insert the second AMs in the data signal at the locations at which the first AMs were removed from the data signal.

Embodiment 6: The communication device of any of embodiments 1-5, further comprising: rate compensation circuitry configured to one or both of i) add idle symbols to the data signal, and ii) delete idle symbols from the data signal; and latency control circuitry configured to i) detect time-sensitive information in the data signal, and ii) selectively control the rate compensation circuitry to pause the one or both of i) the adding idle symbols to the data signal, and ii) deleting idle symbols from the data signal during processing of the time-sensitive information.

Embodiment 7: The communication device of embodiment 6, wherein: the latency control circuitry is configured to i) detect Precision Time Protocol (PTP) packets in the data signal, and ii) selectively control the rate compensation circuitry to pause the one or both of i) the adding idle symbols to the data signal, and ii) deleting idle symbols from the data signal during processing of the PTP packets.

Embodiment 8: The communication device of any of embodiments 1-7, wherein the processing circuitry further comprises: forward error correction (FEC) decoding circuitry configured to perform FEC decoding of the data signal; and FEC encoding circuitry configured to perform FEC encoding of the data signal prior to transmission of the data signal via the second communication interface circuitry.

Embodiment 9: The communication device of any of embodiments 1-8, wherein the first communication interface circuitry is configured to receive the data signal having first AMs specified by the Institute for Electrical and Electronics Engineers (IEEE) standard 802.3.

Embodiment 10: A method for measuring latency through a communication device, comprising: receiving, at first communication interface circuitry of the communication device, a data signal that includes first alignment markers (AMs); determining, by the communication device, respective locations of the first AMs in the data signal; processing, by the communication device, the data signal, the processing including i) removing the first AMs from the data signal and ii) inserting second AMs in the data signal at locations at which the first AMs were removed from the data signal; transmitting, by second communication interface circuitry of the communication device, the data signal after processing by the communication device; and measuring, at the communication device, a latency of the data signal between reception of the data signal at the first communication interface circuitry and transmission of the data signal by the second communication interface circuitry.

Embodiment 11: The method for measuring latency of embodiment 10, wherein the insertion of the second AMs in the data signal at the locations at which the first AMs were removed from the data signal improves accuracy in measured latency measured by the latency measurement circuitry as compared to a scenario in which the second AMs are inserted in the data signal at other locations different from the locations at which the first AMs were removed from the data signal.

Embodiment 12: The method for measuring latency of either of embodiments 10 or 11, further comprising: generating, by the communication device, a tracer signal at a first time in a sideband that is synchronized with the data signal; and detecting, by the communication device, the tracer signal at the second communication interface at a second time; wherein measuring the latency comprises measuring the latency using the first time and the second time.

Embodiment 13: The method for measuring latency of any of embodiments 10-12, wherein: determining the respective locations of the first AMs comprises determining the respective locations of the first AMs as respective offsets between respective locations of the first AMs and respective reference points in the data signal; and inserting the second AMs in the data signal at the locations at which the first AMs were removed from the data signal comprises using the respective offsets to insert the second AMs in the data signal at the locations at which the first AMs were removed from the data signal.

Embodiment 14: The method for measuring latency of any of embodiments 10-13, further comprising: compensating, by the communication device, a data rate of the data signal, including one or both of i) adding idle symbols to the data signal, and ii) deleting idle symbols from the data signal; detecting, by the communication device, time-sensitive information in the data signal; and responsive to detecting the time sensitive information, selectively pausing, by the communication device, the one or both of i) the adding idle symbols to the data signal, and ii) deleting idle symbols from the data signal during processing of the time-sensitive information.

Embodiment 15: The method for measuring latency of embodiment 14, wherein: detecting the time-sensitive information comprising detecting Precision Time Protocol (PTP) packets in the data signal; and selectively pausing the one or both of i) the adding idle symbols to the data signal, and ii) deleting idle symbols from the data signal comprises selectively pausing the one or both of i) the adding idle symbols to the data signal, and ii) deleting idle symbols from the data signal during processing of the PTP packets.

Embodiment 16: The method for measuring latency of any of embodiments 10-15, wherein processing the data signal further comprises: performing, by the communication device, forward error correction (FEC) decoding of the data signal; and performing, by the communication device, FEC encoding of the data signal prior to transmission of the data signal via the second communication interface circuitry.

Embodiment 17: The method for measuring latency of any of embodiments 10-16, wherein receiving the data signal comprises receiving a data signal having first AMs specified by the Institute for Electrical and Electronics Engineers (IEEE) standard 802.3.

Embodiment 18: A communication device, comprising: first communication interface circuitry configured to receive a data signal; second communication interface circuitry configured to transmit the data signal after processing by the communication device; latency measurement circuitry configured to measure a latency of the data signal between reception of the data signal at the first communication interface circuitry and transmission of the data signal by the second communication interface circuitry; rate compensation circuitry configured to one or both of i) add idle symbols to the data signal, and ii) delete idle symbols from the data signal; and latency control circuitry configured to i) detect time-sensitive packets in the data signal, and ii) selectively control the rate compensation circuitry to stop the one or both of i) the adding idle symbols to the data signal, and ii) deleting idle symbols from the data signal during processing of time-sensitive packets.

Embodiment 19: The communication device of embodiment 18, wherein: the latency control circuitry is configured to i) detect Precision Time Protocol (PTP) packets in the data signal, and ii) selectively control the rate compensation circuitry to pause the one or both of i) the adding idle symbols to the data signal, and ii) deleting idle symbols from the data signal during processing of the PTP packets.

Embodiment 20: A method for measuring latency through a communication device, comprising: receiving, at first communication interface circuitry of the communication device, a data signal; processing, by the communication device, the data signal, the processing including rate compensation that includes one or both of i) adding idle symbols to the data signal, and ii) deleting idle symbols from the data signal; detecting, by the communication device, time-sensitive information in the data signal; selectively pausing, by the communication device, the one or both of i) the adding idle symbols to the data signal, and ii) deleting idle symbols from the data signal during processing of time-sensitive information; transmitting, by second communication interface circuitry of the communication device, the data signal after processing by the communication device; and measuring, at the communication device, a latency of the data signal between reception of the data signal at the first communication interface circuitry and transmission of the data signal by the second communication interface circuitry.

Embodiment 21: The method for measuring latency of embodiment 20, wherein: detecting the time-sensitive information comprises detect Precision Time Protocol (PTP) packets in the data signal; and selectively pausing the one or both of i) the adding idle symbols to the data signal, and ii) deleting idle symbols from the data signal comprises selectively pausing the one or both of i) the adding idle symbols to the data signal, and ii) deleting idle symbols from the data signal during processing of the PTP packets.

Embodiment 22: A communication device, comprising: first communication interface circuitry configured to receive a data signal; second communication interface circuitry configured to transmit the data signal after processing by the communication device; tracer generation circuitry configured to generate a tracer signal in connection with the first communication interface circuitry receiving the data signal; processing circuitry configured to i) process the data signal and ii) synchronously advance the tracer signal and the data signal through the communication device from the first communication interface to a second communication interface; and tracer detection circuitry configured to detect the tracer signal in connection with the second communication interface circuitry receiving the data signal; and latency measurement circuitry configured to measure a latency of the data signal through the communication device using i) a first time at which the tracer signal was generated, and ii) a second time at which the tracer signal is detected at the second communication interface circuitry by the tracer detection circuitry.

Embodiment 23: A method for measuring latency through a communication device, comprising: receiving, at first communication interface circuitry of the communication device, a data signal; generating, at the communication device, a tracer signal in connection with the data signal being received at the first communication interface; synchronously advancing the tracer signal and the data signal through the communication device from the first communication interface to a second communication interface; transmitting, by the second communication interface circuitry, the data signal; and measuring, by the communication device, a latency through the communication device using i) a first time at which the tracer signal was generated and ii) a second time at which the tracer signal is detected at the second communication interface.

At least some of the various blocks, operations, and techniques described above may be implemented utilizing hardware, a processor executing firmware instructions, a processor executing software instructions, or any combination thereof. When implemented utilizing a processor executing software or firmware instructions, the software or firmware instructions may be stored in any computer readable memory coupled to the processor, such as a RAM, a ROM, a flash memory, etc. The software or firmware instructions may include machine readable instructions that, when executed by one or more processors, cause the one or more processors to perform various acts.

When implemented in hardware, the hardware may comprise one or more of discrete components, an integrated circuit, an application-specific integrated circuit (ASIC), a programmable logic device (PLD), etc.

While the present invention has been described with reference to specific examples, which are intended to be illustrative only and not to be limiting of the invention, changes, additions and/or deletions may be made to the disclosed embodiments without departing from the scope of the invention.

What is claimed is:

1. A communication device, comprising:
first communication interface circuitry configured to receive a data signal that includes first alignment markers (AMs);
second communication interface circuitry configured to transmit the data signal after processing by the communication device;
latency measurement circuitry configured to measure a latency of the data signal between reception of the data signal at the first communication interface circuitry and transmission of the data signal by the second communication interface circuitry;
processing circuitry configured to process the data signal, the processing circuitry including AM removal circuitry configured to remove the first AMs from the data signal; and
AM insertion circuitry configured to insert second AMs in the data signal at locations at which the first AMs were removed from the data signal.

2. The communication device of claim 1, wherein the insertion of the second AMs in the data signal at the locations at which the first AMs were removed from the data signal improves accuracy in measured latency measured by the latency measurement circuitry as compared to a scenario in which the second AMs are inserted in the data signal at other locations different from the locations at which the first AMs were removed from the data signal.

3. The communication device of claim 1, further comprising:
tracer generation circuitry coupled to the first communication interface circuitry, the tracer generation circuitry configured to generate, at a first time, a tracer signal in a sideband that is synchronized with the data signal; and
tracer monitoring circuitry coupled to the second communication interface circuitry, the tracer monitoring circuitry configured to detect the tracer signal at the second communication interface at a second time;
wherein latency measurement circuitry is configured to measure the latency responsively to the first time and the second time.

4. The communication device of claim 1, further comprising:
circuitry configured to i) detect the locations of the first AMs in the data signal, and ii) provide indications of the locations of the first AMs to the AM insertion circuitry;
wherein the AM insertion circuitry is configured to use the indications of the locations of the first AMs to insert the second AMs in the data signal at the locations at which the first AMs were removed from the data signal.

5. The communication device of claim 4, wherein:
the circuitry configured to provide the indications of the locations of the first AMs to the AM insertion circuitry is configured to generate the indications of the locations of the first AMs to include respective offsets between respective locations of the first AMs and respective reference points in the data signal; and
the AM insertion circuitry is configured to use the respective offsets to insert the second AMs in the data signal at the locations at which the first AMs were removed from the data signal.

6. The communication device of claim 1, further comprising:
rate compensation circuitry configured to one or both of i) add idle symbols to the data signal, and ii) delete idle symbols from the data signal; and
latency control circuitry configured to i) detect time-sensitive information in the data signal, and ii) selectively control the rate compensation circuitry to pause the one or both of i) the adding idle symbols to the data signal, and ii) deleting idle symbols from the data signal during processing of the time-sensitive information.

7. The communication device of claim 6, wherein:
the latency control circuitry is configured to i) detect Precision Time Protocol (PTP) packets in the data signal, and ii) selectively control the rate compensation circuitry to pause the one or both of i) the adding idle symbols to the data signal, and ii) deleting idle symbols from the data signal during processing of the PTP packets.

8. The communication device of claim 1, wherein the processing circuitry further comprises:
forward error correction (FEC) decoding circuitry configured to perform FEC decoding of the data signal; and
FEC encoding circuitry configured to perform FEC encoding of the data signal prior to transmission of the data signal via the second communication interface circuitry.

9. The communication device of claim 1, wherein the first communication interface circuitry is configured to receive the data signal having first AMs specified by the Institute for Electrical and Electronics Engineers (IEEE) standard 802.3.

10. A method for measuring latency through a communication device, comprising:
receiving, at first communication interface circuitry of the communication device, a data signal that includes first alignment markers (AMs);
determining, by the communication device, respective locations of the first AMs in the data signal;
processing, by the communication device, the data signal, the processing including i) removing the first AMs from the data signal and ii) inserting second AMs in the data signal at locations at which the first AMs were removed from the data signal;
transmitting, by second communication interface circuitry of the communication device, the data signal after processing by the communication device; and
measuring, at the communication device, a latency of the data signal between reception of the data signal at the first communication interface circuitry and transmission of the data signal by the second communication interface circuitry.

11. The method for measuring latency of claim 10, wherein the insertion of the second AMs in the data signal at the locations at which the first AMs were removed from the data signal improves accuracy in measured latency measured by the latency measurement circuitry as compared to a scenario in which the second AMs are inserted in the data signal at other locations different from the locations at which the first AMs were removed from the data signal.

12. The method for measuring latency of claim 10, further comprising:
generating, by the communication device, a tracer signal at a first time in a sideband that is synchronized with the data signal; and
detecting, by the communication device, the tracer signal at the second communication interface at a second time;
wherein measuring the latency comprises measuring the latency using the first time and the second time.

13. The method for measuring latency of claim 10, wherein:
determining the respective locations of the first AMs comprises determining the respective locations of the first AMs as respective offsets between respective locations of the first AMs and respective reference points in the data signal; and
inserting the second AMs in the data signal at the locations at which the first AMs were removed from the data signal comprises using the respective offsets to insert the second AMs in the data signal at the locations at which the first AMs were removed from the data signal.

14. The method for measuring latency of claim 10, further comprising:
compensating, by the communication device, a data rate of the data signal, including one or both of i) adding idle symbols to the data signal, and ii) deleting idle symbols from the data signal;
detecting, by the communication device, time-sensitive information in the data signal; and
responsive to detecting the time sensitive information, selectively pausing, by the communication device, the one or both of i) the adding idle symbols to the data signal, and ii) deleting idle symbols from the data signal during processing of the time-sensitive information.

15. The method for measuring latency of claim 14, wherein:
detecting the time-sensitive information comprising detecting Precision Time Protocol (PTP) packets in the data signal; and
selectively pausing the one or both of i) the adding idle symbols to the data signal, and ii) deleting idle symbols from the data signal comprises selectively pausing the one or both of i) the adding idle symbols to the data signal, and ii) deleting idle symbols from the data signal during processing of the PTP packets.

16. The method for measuring latency of claim 10, wherein processing the data signal further comprises:
performing, by the communication device, forward error correction (FEC) decoding of the data signal; and
performing, by the communication device, FEC encoding of the data signal prior to transmission of the data signal via the second communication interface circuitry.

17. The method for measuring latency of claim 10, wherein receiving the data signal comprises receiving a data signal having first AMs specified by the Institute for Electrical and Electronics Engineers (IEEE) standard 802.3.

18. A communication device, comprising:
first communication interface circuitry configured to receive a data signal;
second communication interface circuitry configured to transmit the data signal after processing by the communication device;
latency measurement circuitry configured to measure a latency of the data signal between reception of the data signal at the first communication interface circuitry and transmission of the data signal by the second communication interface circuitry;
rate compensation circuitry configured to one or both of i) add idle symbols to the data signal, and ii) delete idle symbols from the data signal; and
latency control circuitry configured to i) detect time-sensitive packets in the data signal, and ii) selectively control the rate compensation circuitry to stop the one or both of i) the adding idle symbols to the data signal, and ii) deleting idle symbols from the data signal during processing of time-sensitive packets.

19. The communication device of claim 18, wherein:
the latency control circuitry is configured to i) detect Precision Time Protocol (PTP) packets in the data signal, and ii) selectively control the rate compensation circuitry to pause the one or both of i) the adding idle symbols to the data signal, and ii) deleting idle symbols from the data signal during processing of the PTP packets.

20. A method for measuring latency through a communication device, comprising:
receiving, at first communication interface circuitry of the communication device, a data signal;
processing, by the communication device, the data signal, the processing including rate compensation that includes one or both of i) adding idle symbols to the data signal, and ii) deleting idle symbols from the data signal;
detecting, by the communication device, time-sensitive information in the data signal;
selectively pausing, by the communication device, the one or both of i) the adding idle symbols to the data signal, and ii) deleting idle symbols from the data signal during processing of time-sensitive information;
transmitting, by second communication interface circuitry of the communication device, the data signal after processing by the communication device; and
measuring, at the communication device, a latency of the data signal between reception of the data signal at the first communication interface circuitry and transmission of the data signal by the second communication interface circuitry.

21. The method for measuring latency of claim 20, wherein:
detecting the time-sensitive information comprises detect Precision Time Protocol (PTP) packets in the data signal; and
selectively pausing the one or both of i) the adding idle symbols to the data signal, and ii) deleting idle symbols from the data signal comprises selectively pausing the one or both of i) the adding idle symbols to the data signal, and ii) deleting idle symbols from the data signal during processing of the PTP packets.
